(19) United States
(12) Patent Application Publication
(10) Pub. No.: US 2026/0252252 A1
(43) Pub. Date: Aug. 27, 2026

(54) SECTOR-BASED DATA COMPRESSION

(71) Applicant: Micron Technology, Inc., Boise, ID (US)

(72) Inventors: Massimiliano Patriarca, Milano (IT); Daniele Baliuchi, MI (IT); Graziano Mirichigni, Vimercate (IT)

(21) Appl. No.: 19/541,820

(22) Filed: Feb. 17, 2026

Related U.S. Application Data
(60) Provisional application No. 63/762,984, filed on Feb. 25, 2025.

(51) Int. Cl. G06F 3/06

(52) U.S. Cl. CPC G06F 3/064; G06F 2212/401

(57) ABSTRACT

Systems and methods are disclosed, including receiving write data at a memory array of a memory system. The memory array includes multiple sectors of a same memory cell size, and a sector is assigned a block size to store compressed data of the assigned block size and different sectors of the memory array are assigned a different block size. The write data is compressed. The compressed write data is written to an invalid data block of a first sector having a smallest block size that can store the compressed write data; and the compressed write data is written to an open data block indicated by a write cursor of a second sector assigned a block size that can store the compressed write data when an invalid data block is not available to store the compressed write data.

### PRIORITY APPLICATION

This application claims the benefit of priority to U.S. Provisional Application Ser. No. 63/762,984, filed Feb. 25, 2025, which is incorporated herein by reference in its entirety.

### BACKGROUND

Memory devices are semiconductor circuits that provide electronic storage of data for a host system (e.g., a computer or other electronic device). Memory devices may be volatile or non-volatile. Volatile memory requires power to maintain data and includes devices such as random-access memory (RAM), static random-access memory (SRAM), dynamic random-access memory (DRAM), or synchronous dynamic random-access memory (SDRAM), among others.

Host systems (or hosts) typically include a host processor, a first amount of main memory (e.g., often volatile memory, such as DRAM) to support the host processor, and one or more memory systems (e.g., often non-volatile memory, such as flash memory, and may include volatile memory) that provide additional storage to retain data in addition to or separate from the main memory.

A memory system can include a memory controller and one or more memory devices, including a number of dies or logical units (LUNs). In certain examples, each die can include a number of memory arrays and peripheral circuitry thereon, such as die logic or a die processor. The memory controller can include interface circuitry configured to communicate with a host (e.g., the host processor or interface circuitry) through a communication link (e.g., a bidirectional parallel or serial communication interface). The memory controller can receive commands or operations from the host system in association with memory operations or instructions, such as read or write operations to transfer data (e.g., user data and associated integrity data, such as error data or address data, etc.) between the memory devices and the host device, erase operations to erase data from the memory devices, perform drive management operations (e.g., data migration, garbage collection, bank retirement), etc.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram of an example computing system including a host system and a memory system.

FIG. 2 is a block diagram of portions of an example of a memory system.

FIG. 3 is a block diagram of portions of another example of a memory system.

FIG. 4 is an illustration of an example of sectors of a memory array.

FIG. 5 is an illustration of another example of sectors of a memory array.

FIGS. 6-7 illustrate an example of a defragmenting process for sectors of a memory array.

FIG. 8 is a block diagram of an example of sectorization of a memory array.

FIG. 9 is a flow diagram of an example of a method of operating a memory system.

FIGS. 10-13 illustrate an example of data placement in the sectors of the memory array.

FIGS. 14-19 illustrate an example of another approach to a defragmenting process for sectors of a memory array.

FIG. 20 illustrates an example block diagram of a computing system.

### DETAILED DESCRIPTION

Software (e.g., programs), instructions, operating systems (OS), and other data are typically stored on storage systems and accessed for use by a host processor. Main memory (e.g., RAM) is typically faster, more expensive, and a different type of memory device (e.g., volatile) than a majority of the memory devices of the memory system (e.g., non-volatile, such as an SSD, etc.). In addition to the main memory, host devices can include different levels of volatile memory, such as a group of static memory (e.g., a cache, often SRAM), often faster than the main memory, in certain examples, configured to operate at speeds close to or exceeding the speed of the host processor, but with lower density and higher cost. Systems can include high speed, low latency compute express link (CXL) compatible memory. The CXL compatible memory provides a high capacity link between processors and the memory system.

Memory devices include individual memory die, which may, for example, include a storage region comprising one or more arrays of memory cells, implementing one (or more) selected storage technologies. Such memory die will often include support circuitry for operating the memory array(s). Other examples, sometimes known generally as “managed memory devices,” include assemblies of one or more memory die associated with controller functionality configured to control operation of the one or more memory dies. Such controller functionality can simplify interoperability with an external host device. In such managed memory devices, the controller functionality may be implemented on one or more dies also incorporating a memory array, or on a separate die. In other examples, one or more memory devices may be combined with controller functionality to form a solid-state drive (SSD) storage volume.

Embodiments of the present disclosure are described in the example of managed memory devices. For example, managed memory devices implementing NAND flash memory cells can be referred to as managed NAND or mNAND devices. These examples, however, are not limiting on the scope of the disclosure, which may be implemented in other forms of memory devices (e.g., DRAM) and/or with other forms of storage technology.

Both NOR and NAND flash architecture semiconductor memory arrays are accessed through decoders that activate specific memory cells by selecting the word line coupled to their gates. In a NOR architecture semiconductor memory array, once activated, the selected memory cells place their data values on bit lines, causing different currents to flow depending on the state at which a particular cell is programmed. In a NAND architecture semiconductor memory array, a high bias voltage is applied to a drain-side select gate (SGD) line. Word lines coupled to the gates of the unselected memory cells of each group are driven at a specified pass voltage (e.g., Vpass) to operate the unselected memory cells of each group as pass transistors (e.g., to pass current in a manner unrestricted by their stored data values). Current then flows from the source line to the bit line through each series coupled group, restricted only by the selected memory cells of each group, placing current encoded data values of selected memory cells on the bit lines.

Each flash memory cell in a NOR or NAND architecture semiconductor memory array can be programmed individually or collectively to one or a number of programmed states. For example, a single-level cell (SLC) can represent one of two programmed states (e.g., 1 or 0), representing one bit of data. Flash memory cells can also represent more than two programmed states, allowing the manufacture of higher density memories without increasing the number of memory cells, as each cell can represent more than one binary digit (e.g., more than one bit). Such cells can be referred to as multi-state memory cells, multi-digit cells, or multi-level cells (MLCs). In certain examples, MLC can refer to a memory cell that can store two bits of data per cell (e.g., one of four programmed states), a triple-level cell (TLC) can refer to a memory cell that can store three bits of data per cell (e.g., one of eight programmed states), and a quad-level cell (QLC) can store four bits of data per cell. MLC is used herein in its broader context, to refer to any memory cell(s) that can store more than one bit of data per cell (i.e., that can represent more than two programmed states).

Managed memory devices can include a number of memory devices, including a number of dies or logical units (e.g., logical unit numbers or LUNs), and can include one or more processors or other controllers performing logic functions required to operate the memory devices or interface with external systems. Such managed memory devices can include one or more flash memory dies, including a number of memory arrays and peripheral circuitry thereon. The flash memory arrays can include a number of blocks of memory cells organized into a number of physical pages. Managed NAND devices can include one or more arrays of volatile and/or nonvolatile memory separate from the NAND storage array, and either within or separate from a controller. Managed NAND devices can receive commands from a host or a host in association with memory operations, such as read or write operations to transfer data (e.g., user data and associated integrity data, such as error data and address data, etc.) between the memory devices and the host, or erase operations to erase data from the memory devices.

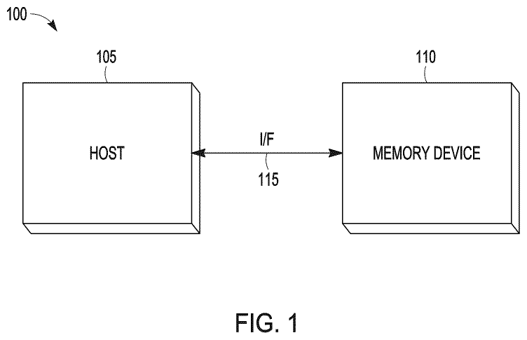

FIG. 1 illustrates an example computing system 100 including a host system or host 105 and a memory system 110. The host 105 can include host processing circuitry (e.g., a host processor, a host central processing unit (CPU), or one or more other device, processor, or controller, and other host circuitry (e.g., a memory management unit (MMU), interface circuitry, assessment circuitry, etc.). In certain examples, the host 105 can include a main memory that includes DRAM to support operation of the host processing circuitry. The host 105 and the memory system 110 communicate over a communication interface 115 (e.g., a bidirectional parallel or serial communication interface). The interface 115 may be CXL-compatible.

The memory system 110 can include one or more other memory devices, and the communication interface 115 (I/F) can include one or more other interfaces, depending on the host 105 and the memory system 110. Each of the host 105 and the memory system 110 can include a number of receiver or driver circuits configured to receive or send signals over the communication interface 115, or interface circuits, such as data control units, sampling circuits, or other intermedia circuits configured to process data to be communicated over, or otherwise process data received from the communication interface 115 for use by the host 105, the memory system 110, or one or more other circuits or devices.

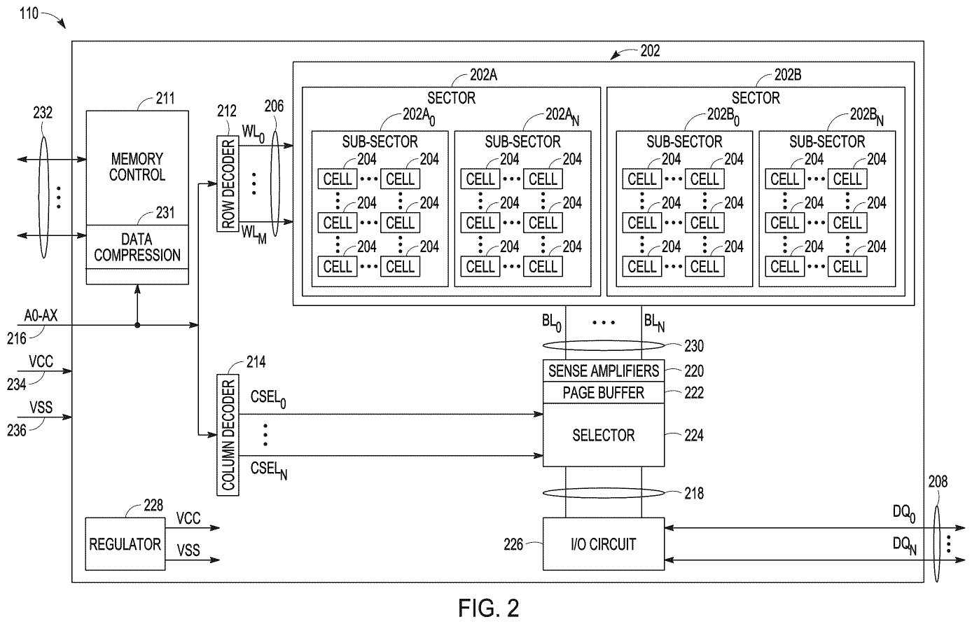

FIG. 2 is a block diagram of an example of portions of a memory system 110. The memory system 110 may be a Type 3 CXL memory system. The memory system 100 includes a memory array 202 having a plurality of memory cells 204, and one or more circuits or components to provide communication with, or perform one or more memory operations on, the memory array 202. Although shown with a single memory array 202, in other examples, one or more additional memory arrays, dies, or LUNs can be included herein. The memory system 110 can include a row decoder 212, a column decoder 214, sense amplifiers 220, a page buffer 222, a selector 224, an input/output (I/O) circuit 226, and a memory controller 211.

The memory cells 204 of the memory array 202 can be arranged in sectors, such as first and second sectors 202A, 202B. Each sector can include sub-sectors. For example, the first sector 202A can include first and second sub-sectors 202A₀, 202Aₙ, and the second sector 202B can include first and second sub-sectors 202B₀, 202Bₙ. Each sub-sector can include a number of physical pages, each page including a number of memory cells 204. Although illustrated herein as having two sectors, each sector having two sub sectors, and each sub-sector having a number of memory cells 204, in other examples, the memory array 202 can include more or fewer sectors, sub-sectors, memory cells, etc. In other examples, the memory cells 204 can be arranged in a number of rows, columns, pages, sub-sectors sectors, etc., and accessed using, for example, access lines 206, first data lines 230, or one or more select gates, source lines, etc.

The memory controller may be embedded in the memory device 110. The memory controller 211 of the memory system 110 includes controller processing circuitry (e.g., a processor or processing device, an application specific integrated circuit (ASIC), or programmable gate array (PGA)) to perform the functions described for the memory controller 211. The memory controller 211 can control memory operations of the memory system 110 according to one or more signals or instructions received on control lines 232, including, for example, one or more clock signals or control signals that indicate a desired operation (e.g., write, read, erase, etc.), or address signals (A0-AX) received on one or more address lines 216. One or more devices external to the memory system 110 can control the values of the control signals on the control lines 232, or the address signals on the address line 216. Examples of devices external to the memory system 110 can include, but are not limited to, a host, a processor, or one or more circuits or components not illustrated in FIG. 2.

The memory system 110 can use access lines 206 and first data lines 230 to transfer data to (e.g., a write or erase operation) or from (e.g., a read operation) one or more of the memory cells 204. The row decoder 212 and the column decoder 214 can receive and decode the address signals (A0-AX) from the address line 216, can determine which of the memory cells 204 are to be accessed, and can provide signals to one or more of the access lines 206 (e.g., one or more of a plurality of word lines (WL0-WLm)) or the first data lines 230 (e.g., one or more of a plurality of bit lines (BL0-BLn)), such as described above.

The memory system 110 can include sense circuitry, such as the sense amplifiers 220, configured to determine the values of data on (e.g., read), or to determine the values of data to be written to, the memory cells 204 using the first data lines 230. For example, in a selected string of memory cells 204, one or more of the sense amplifiers 220 can read a logic level in the selected memory cell 204 in response to a read current flowing in the memory array 202 through the selected string to the data lines 230.

One or more devices external to the memory system 110 can communicate with the memory system 110 using the I/O lines (DQ0-DQN) 208, address lines 216 (A0-AX), or control lines 232. The input/output (I/O) circuit 226 can transfer values of data in or out of the memory system 110, such as in or out of the page buffer 222 or the memory array 202, using the I/O lines 208, according to, for example, the control lines 232 and address lines 216. The page buffer 222 can store data received from the one or more devices external to the memory system 110 before the data is programmed into relevant portions of the memory array 202 or can store data read from the memory array 202 before the data is transmitted to the one or more devices external to the memory system 110.

The column decoder 214 can receive and decode address signals (A0-AX) into one or more column select signals (CSEL0-CSELn). The selector 224 (e.g., a select circuit) can receive the column select signals (CSEL0-CSELn) and select data in the page buffer 222 representing values of data to be read from or to be programmed into memory cells 204. Selected data can be transferred between the page buffer 222 and the I/O circuit 226 using second data lines 218.

The memory controller 211 can receive positive and negative supply signals, such as a supply voltage (Vcc) 234 and a negative supply (Vss) 236 (e.g., a ground potential), from an external source or supply (e.g., an internal or external battery, an AC-to-DC converter, etc.). In certain examples, the memory controller 211 can include a regulator 228 to internally provide positive or negative supply signals.

The memory controller 211 accesses the physical memory space of the memory array 202 as sectors. The memory controller 211 receives data from the host 105, performs data compression on the received data, and stores compressed data in the memory array. The data compression engine 231 may be embedded with the memory controller 211 in the memory device.

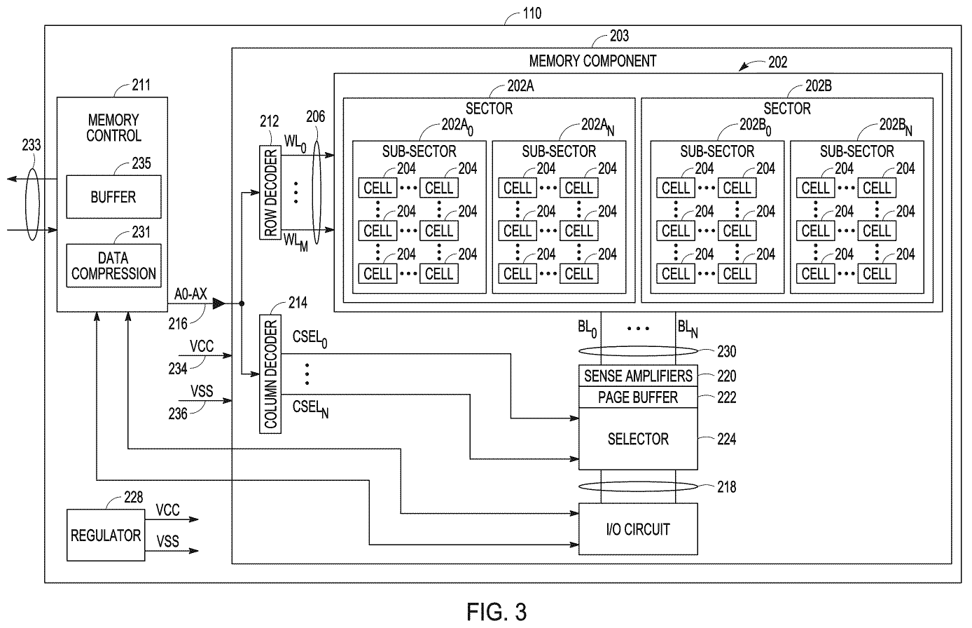

FIG. 3 is a block diagram of another example of portions of a memory system 110. The memory controller 211 and the data compression are included in a memory device as a component separate from the memory component 203. The memory device may include one or more memory components 203. The host 105 is connected to the memory controller 211 through a bus 233. If the memory device is a CXL device, the bus 233 may be based on a Peripheral Component Interconnect Express Interface Express Physical layer (PCIe PHY) and may be a unidirectional bus. The bus 233 delivers command, address, and data signals. The data compression engine 231 is within the memory controller 211. The memory controller 211 includes a buffer 235 that may include volatile memory. Uncompressed data may be stored in the buffer 235 from which the data can be accessed with a shorter latency. Uncompressed data is read from the buffer 235, compressed, and stored in memory. Any host write requires reading a compressed block from the memory component 203, uncompressing the block, modifying he uncompressed data, compressing the modified data, and writing compressed data back to memory. The data in memory may be encrypted data.

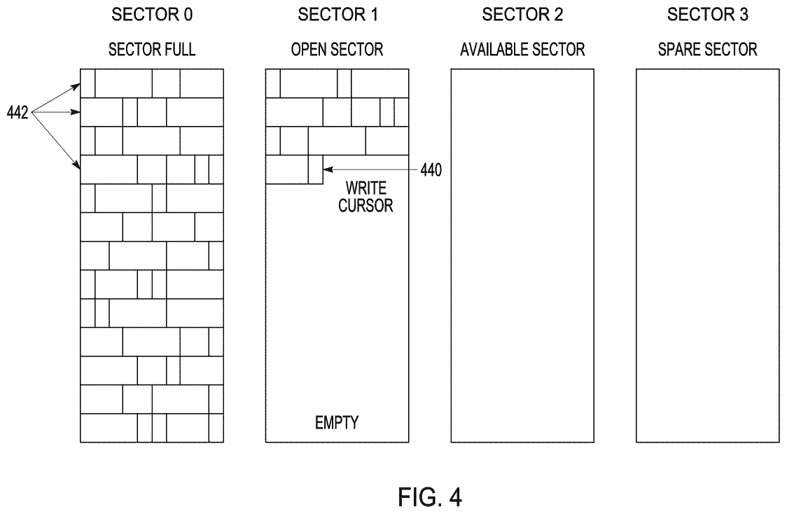

FIG. 4 is an illustration of an example of four sectors (Sector 0 to Sector 3) of a memory array (e.g., memory array 202 in FIG. 2). Sector 0 is a full sector, Sector 1 is an open sector to receive compressed data at the location of the write cursor 440 or write pointer, Sector 2 is an available sector, and sector 3 is a spare sector. Data received from the host 105 is compressed and written into compressed data blocks 442. The compressed data is written into data blocks of varying size in a sector as shown by the different sized blocks in sector 0 and sector 1. For a host read operation, compressed data is read from the data block, decompressed, and sent to the host 105. For a subsequent host write to a data block, a compressed data block is decompressed, new host data is written into the decompressed data block, and the data is compressed again.

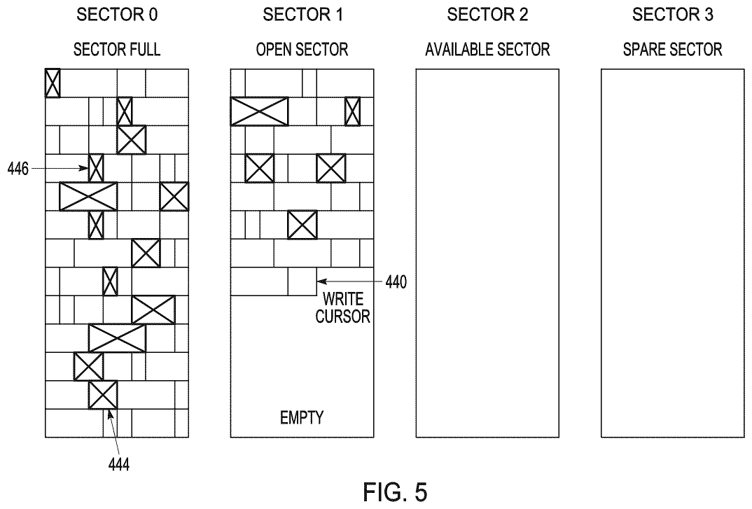

FIG. 5 is an illustration of an example of the four sectors of FIG. 4 after multiple write cycles. If the new size of the compressed data block is equal to or smaller than the original compressed data block, the new data block is stored at the same place. If the new compressed data block is larger, the compressed data block is moved to the location indicated by the write cursor 440. If the data block is moved, the original data block is an invalid data block 444 having invalid data. If the new size of the compressed data block is smaller than the original compressed data block and the new data block is stored at the same place, a portion of the data block has invalid data 446.

The cycles of compressing and decompressing data may lead to sectors containing many blocks of invalid data. A defragmenting (or defrag) process is initiated when only a few empty sectors remain. The defrag process empties a sector of data, and the sector becomes an available sector or empty sector.

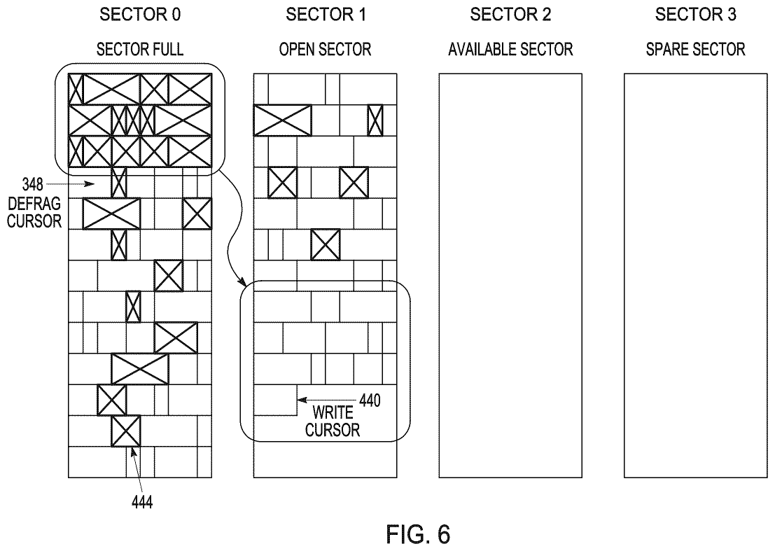

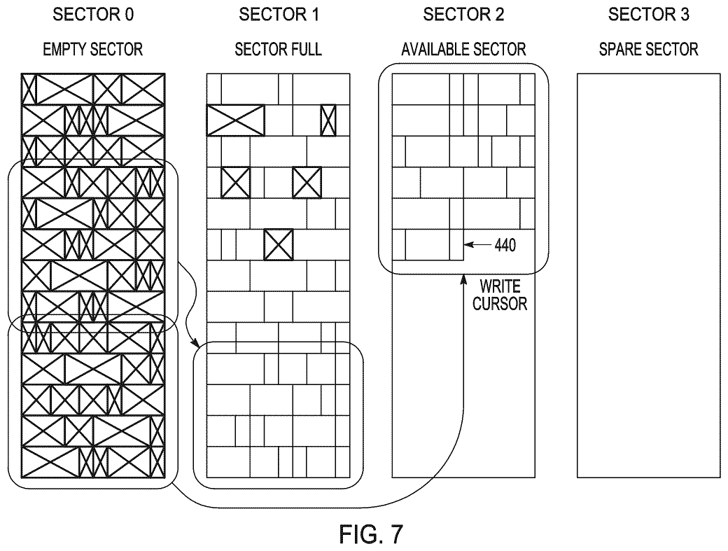

FIGS. 6 and 7 illustrate a defrag process for the sectors of the example of FIG. 5. In FIG. 6, sector 0 is selected as a source sector. A defrag cursor 348 may be used to move valid compressed data remaining in full sector 0 is moved open sector 1 at the location of the write cursor 440. In FIG. 7, sector 1 is full and valid compressed data is moved to sector 2 until sector 0 is completely empty. Sector 2 is now an open sector and sector 0 is an available sector.

The process to write compressed data in FIGS. 4 and 5 and the process to defrag data in FIGS. 6 and 7 can be improved by changing the memory sectorization approach and in managing the reuse of the sectors.

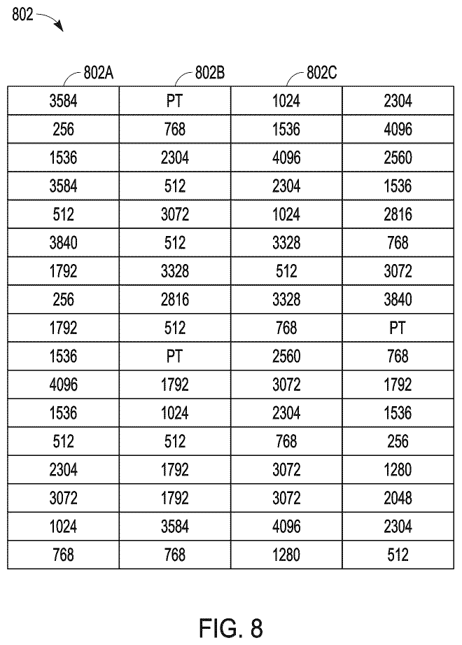

FIG. 8 is a block diagram of an example of sectorization of a memory array 802. The example shows 68 sectors where each rectangle in FIG. 8 is a sector. The sectors of an implementation of the memory system 110 may be of any size (e.g., 128 Mega-Byte or 128 MB, 256 MB, 512 MB, etc.), but the sectors of the implementation have a uniform size (i.e., the sectors are all one of 128 MB, 256 MB, 512 MB, etc.).

The sectors are assigned types by the memory controller 211. In the example of FIG. 8, inside the sector rectangle is a sector type. The sector type can be a page table (PT) sector or a sector block size. In FIG. 8, sector 802B is a page table sector type and sector 802A is a block size sector type of block size 3584 Bytes (3854B). Sector 802C is a block size sector type of block size 1024 Bytes (1024B). The sector block size is the size of the compressed data block that is stored in the sector. For example, sector 802A may be 128MB and data blocks or Managed Units (MUs) stored in the sector are all 3584B. The compressed data blocks stored within a sector have a unform size based on the sector size type. Different sectors have different size types (e.g., 256 B, 512 B, . . . , 4096 B). Other block sizes can be used (e.g., 64 B, 128 B, etc.). The memory controller 211 can assign a same size type to more than one sector. A sector with a page table type (e.g., sector 802 B) stores one or more page tables. The page tables map virtual or logical data blocks of the host to compressed data blocks of the memory array. Multiple sectors can be page table sectors. The memory controller 211 may also assign some sectors as spare type. The spare sectors can be used increase the capacity if needed. The memory controller 211 may reserve one or more page table sectors. The memory controller 211 may recurrently reassign the sector types based on changes in the memory system 110. For example, there may be a need for more sectors to be assigned a particular sector type due to the compression rate of the data compression algorithm.

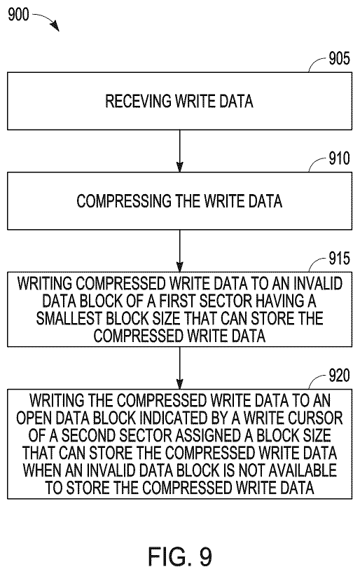

FIG. 9 is a flow diagram of an example of a method 900 of operating a memory system 110. At block 905, write data is received from the host 105 at the memory array 802 of the memory system 110. As in FIG. 8, the memory array is divided into multiple data sectors and page table sectors. The data sectors are assigned different data block sizes. At block 910, the write data is compressed by a data compression engine 231 of the memory controller 211 of the memory system 110. The data compression engine 231 may use any compression algorithm.

At block 915, the memory controller 211 looks for an invalid data block containing invalid data in a sector having the smallest block size that can store the compressed write data. If an invalid data block is available, the memory controller 211 writes the compressed write data into the invalid data block of the sector. At block 920, if an invalid data block is not available, the memory controller writes the compressed write data into an open sector of the smallest block size at the location of the write cursor.

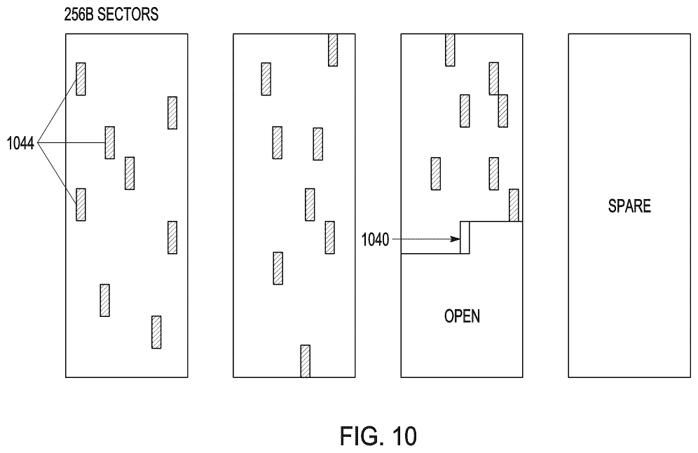

FIGS. 10-13 illustrate an example of data placement in the sectors of the memory array 802 following the method 900 of FIG. 9. The sectors in FIGS. 10-13 all have the same number of memory cells but are assigned different data block sizes. FIG. 10 shows four 256 B sectors that store data blocks of compressed data of size 256 B. The sectors need not be adjacent, and a sector can be any of the 256 B sectors in FIG. 8. Two of the sectors are full, one sector is open, and one sector is a spare sector to store 256B data blocks of compressed data. The rectangles within the sectors represent invalid data blocks 1044 of size 256 B. A write cursor 1040 points to the next open 256 B block of data in the open sector.

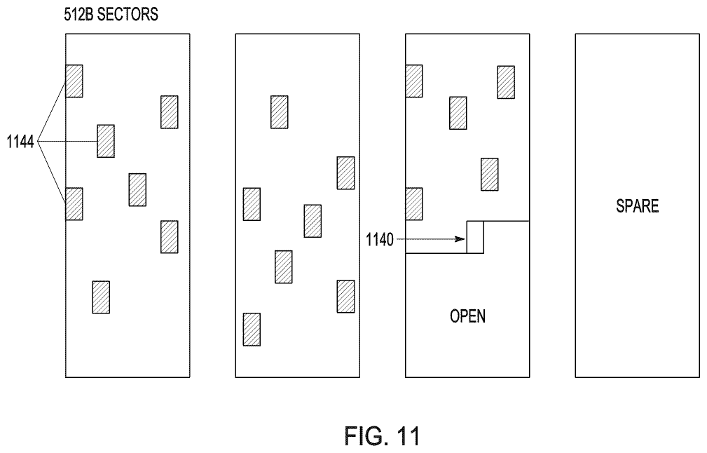

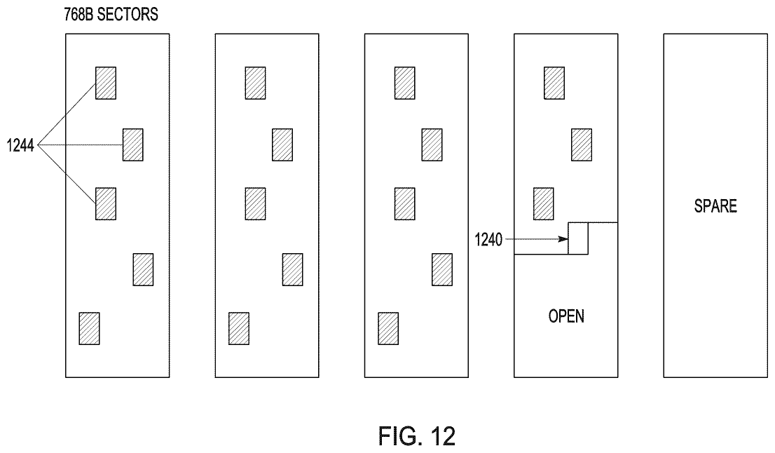

FIG. 11 shows four 512 B sectors that store data blocks of size 512 B. Two of the sectors are full, one sector is open, and one sector is a spare sector to store 512 B data blocks of compressed data. The rectangles within the sectors represent invalid data blocks 1144 of size 512 B. A write cursor 1140 points to the next open 512 B block of data in the open sector. FIG. 12 shows five 768 B sectors that store data blocks of size 768 B. Three of the sectors are full, one sector is open, and one sector is a spare sector to store 768 B data blocks of compressed data. The rectangles within the sectors represent invalid data blocks 1244 of size 768 B. A write cursor 1240 points to the next open 768 B block of data in the open sector.

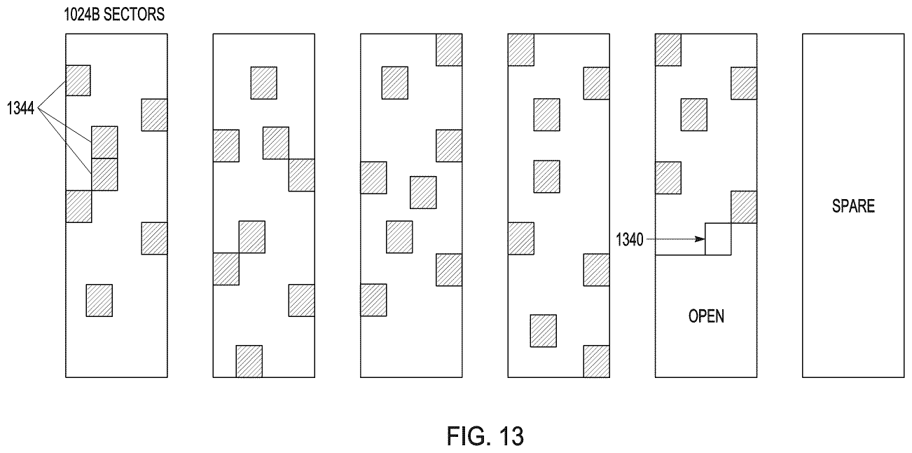

FIG. 13 shows six 1024 B sectors that store data blocks of size 1024 B. Four of the sectors are full, one sector is open, and one sector is a spare sector to store 1024 B data blocks of compressed data. The rectangles within the sectors represent invalid data blocks 1344 of size 1024 B. A write cursor 1340 points to the next open 1024 B block of data in the open sector.

FIGS. 10-13 show there is a write cursor for each data block size. In the example of FIG. 8, there would be sixteen write cursors, one for an open sector for each data block size. There are also invalid pointers that indicate free invalid data blocks that can be written to. The invalid pointers may be collected in First-In First-Out buffers (FIFOs) or other type of buffer. There is a FIFO for each sector size to store invalid pointers. The FIFOs may be in volatile memory embedded in the memory controller 211 (e.g., SRAM) and may be moved to volatile memory connected to the memory controller 211 (e.g., DRAM) if the content of the FIFOs becomes too large.

The invalid blocks pointed to by the invalid pointers are the first invalid blocks to be reused to reduce FIFO depth. If write data is received by the memory system 110 and the compressed data is 256 B or less, the memory controller 211 writes the compressed block of data into an invalid data block of one of the 256 B sector blocks of FIG. 10 indicated by an invalid pointer. If there is not a 256 B invalid data block available for writing in the sectors of FIG. 10, the compressed data is written at in the open sector at the location of the 256 B write cursor 1040. After the data is written, a page table sector is updated to map the host virtual data block to the physical location of the compressed data block.

If the compressed data block is greater than 256 B and not greater than 512 B, the memory controller 211 writes the compressed data into an invalid data block of one of the 512 B sector blocks of FIG. 11 indicated by an invalid pointer for the 512 B sectors or writes the compressed data into the 512 B open sector at the location indicated by the 512 B write cursor 1140. If the compressed data block is greater than 512 B and not greater than 768 B, the memory controller 211 writes the compressed data into an invalid data block of one of the 768 B sector blocks of FIG. 12 indicated by an invalid pointer for the 768 B sectors or writes the compressed data into the 768 B open sector at the location indicated by the 768 B write cursor 1240 if a 768 B invalid block is unavailable. Similarly, If the compressed data block is greater than 768 B and not greater than 1024 B, the memory controller 211 writes the compressed data into an invalid data block of one of the 1024 B sector blocks of FIG. 13 indicated by an invalid pointer for the 1024 B sectors or writes the compressed data into the 1024 B open sector at the location indicated by the 1024 B write cursor 1340 if a 1024 B invalid block is unavailable. A page table sector is updated whenever data is written to a new location.

Invalid data blocks are created by writing and updating the compressed data in the memory array 802. When updated data is received from the host 105, the memory controller 211 reads the compressed original data from a data block of a sector. The memory controller 211 decompresses the compressed data and updates the decompressed data with the received write data. The memory controller 211 compresses the updated decompressed data into compressed write data. If the new compressed write data is the same or less, the memory controller 211 writes the new compressed data back into the data block. The page table does not need to be updated if the data is rewritten to the same data block. If the new compressed data is larger than the data block, the memory controller 211 writes the new compressed data in a sector of the smallest data block size that can hold the new compressed data and indicates that the data in the old data block is invalid. The page table is updated in a page table sector, and the invalid data location is added to the FIFO for data blocks of the corresponding size.

Because the invalid data blocks are filled first, open sectors will be filled up less often, reducing the frequency of defragmenting sectors. The defrag process can be improved by managing the reuse of the sectors of the memory array. The defrag process may be triggered when a sector has less than a threshold level of valid data (e.g., 10% of valid data) and the remainder of the sector has invalid data (e.g., 90% invalid data). The remaining valid data is moved from the sector if there are enough invalid data blocks in other sectors of the same assigned data block size to which the valid data blocks can be moved. The valid data blocks are moved to new sectors using the same criteria described previously herein regarding a host write to memory. The memory controller 211 locks the source sector so that data is not written to the source sector. Moving the valid data blocks to invalid data blocks indicated by the invalid pointers is given preference over moving the valid data blocks to open locations indicated by a write cursor. When the source sector is empty of valid data, the memory controller 211 may assign a new data block size to the source sector. Data blocks of a different size can be written to the source sector after defragmenting and reassigning to the new size. The source sector may be assigned as a page table sector.

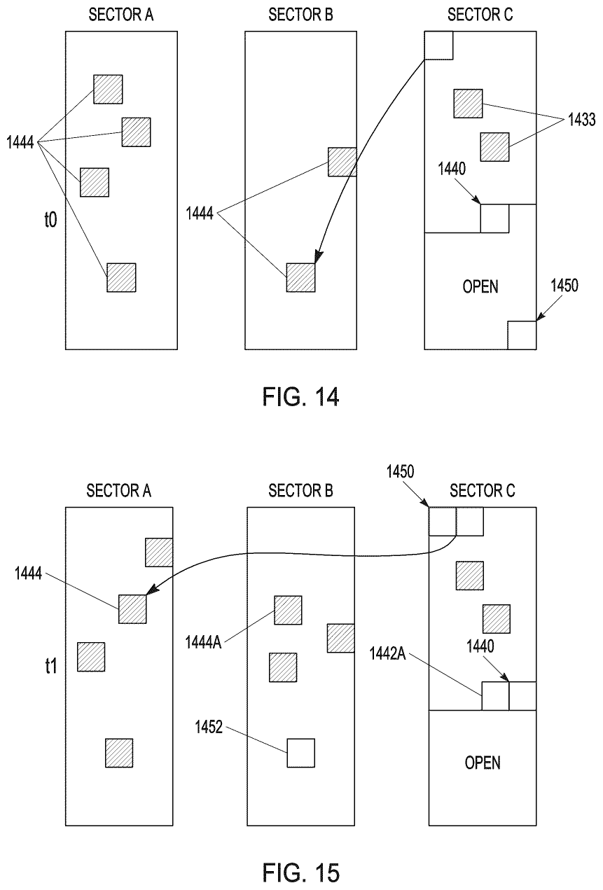

FIGS. 14-19 illustrate an example of another approach to a defrag process. The defrag process includes sector filling. In FIGS. 14-19 the sectors are labeled Sector A, Sector B, and Sector C. The sectors are assigned the same data size. The open sector is Sector C and the write cursor 1440 for the data block size points to a location in Sector C. The squares in the sectors indicate invalid data blocks 1444. The open sector is implemented as a circular buffer.

FIG. 14 shows that at time t0, the first valid data block of the open sector is moved to an invalid block 1444 in Sector B. A last cursor 1450 shows the last data block of contiguous space in the open sector. The valid data from the open sector is used to fill invalid data blocks of sectors A and B indicated by a pointer for the free list for the data block size. Data is moved from the open sector from the next location in the sector indicated by the last cursor 1450. The corresponding page table is updated in a page table sector.

FIG. 15 shows that at time t1, the second valid data block of the open sector is moved to an invalid block 1444 in Sector A according to the free list. The data block 1452 in Sector B is shown storing valid data moved from the open sector. FIG. 15 shows that a new invalid data block 1444A appears in Sector B due to compressed data being updated. The new compressed data is written in Sector C in the block 1442A which was indicated by the write cursor. Then, the write cursor 1440 and the last cursor 1450 are updated. The corresponding page table is updated.

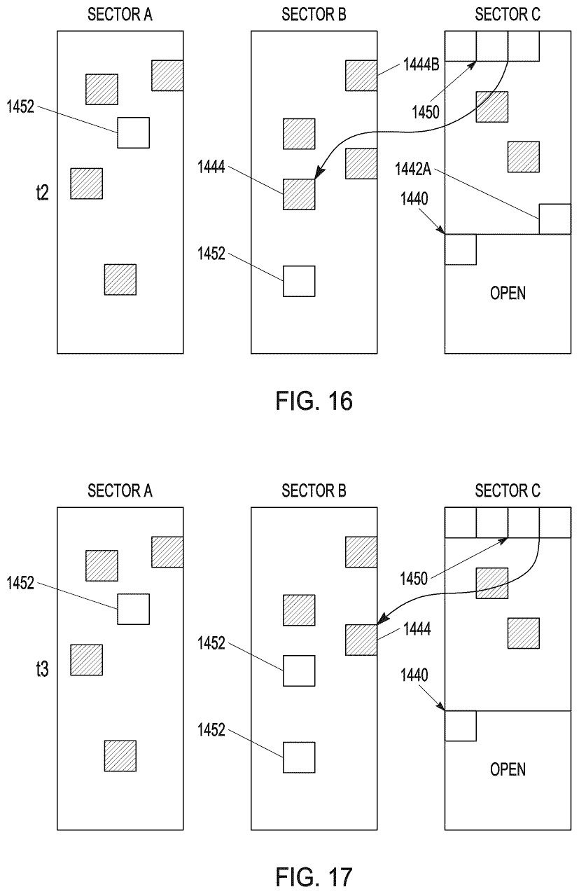

FIG. 16 shows that at time t2, the third valid data block of the open sector is moved to an invalid block 1444 in Sector B. The data block 1452 in Sector A is shown storing valid data moved from the open sector. FIG. 16 shows that a new invalid data block 1444B appears in Sector B due to compressed data being updated. The compressed data was written to the open sector at the location 1442A which was indicated by the write cursor. The write cursor 1440 and the last cursor 1450 are updated.

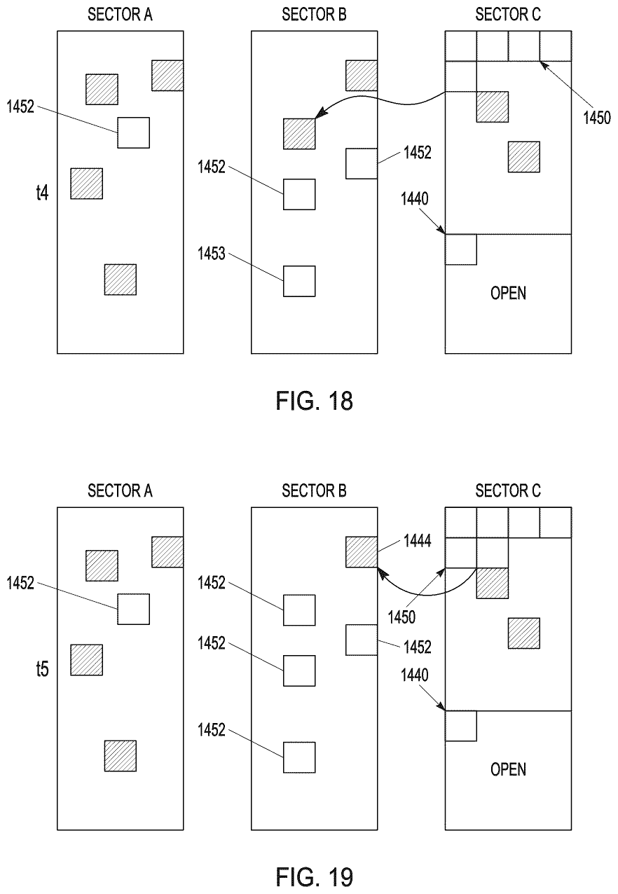

FIG. 17 shows that at time t3, the fourth valid data block of the open sector is moved to an invalid block 1444 in Sector B. FIG. 18 shows that at time t4, the fifth valid data block of the open sector is moved to an invalid block 1444 in Sector B. FIG. 19 shows that at time t5, the sixth valid data block of the open sector is moved to an invalid block 1444 in Sector B. FIGS. 14-19 show the open sector being managed as a circular buffer with the write cursor indicating the first location of a contiguous open portion of the open sector and the last cursor indicating the last location of the contiguous open portion.

The systems and methods described herein provide sector-based virtual-to-physical and physical-to-virtual table management techniques for data compression and decompression. The techniques include memory sectorization, sector management and reuse, and sector defragmenting.

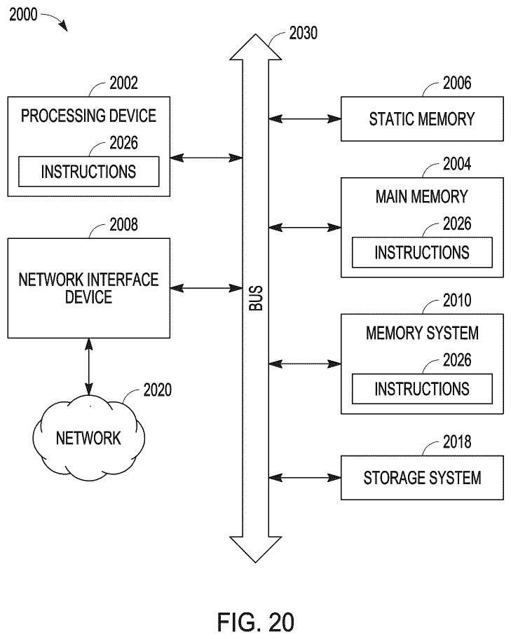

FIG. 20 illustrates a block diagram of an example machine 2000 (e.g., a computing system) upon which any one or more of the techniques (e.g., methodologies) discussed herein may be performed. In alternative embodiments, the machine 2000 may operate as a standalone device or may be connected (e.g., networked) to other machines. In a networked deployment, the machine 2000 may operate in the capacity of a network node. In an example, the machine 2000 may act as a peer machine in peer-to-peer (P2P) (or other distributed) network environment. The machine 2000 may be a personal computer (PC), a tablet PC, a set-top box (STB), a personal digital assistant (PDA), a mobile telephone, a web appliance, an IoT device, an automotive computing system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 2000 (e.g., computing system) may include a processing device 2002 (e.g., a hardware processor, a central processing unit (CPU), a graphics processing unit (GPU), a hardware processor core, or any combination thereof, etc.), a main memory 2004 (e.g., read-only memory (ROM), dynamic random-access memory (DRAM) such as synchronous DRAM (SDRAM) or Rambus DRAM (RDRAM), etc.), a static memory 2006 (e.g., static random-access memory (SRAM), etc.), a memory system 2010, and a storage system 2018, some or all of which may communicate with each other via a communication interface (e.g., a bus) 2030.

The processing device 2002 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 2002 can also be one or more special-purpose processing devices such as an application specific integrated circuit (ASIC), a field programmable gate array (FPGA), a digital signal processor (DSP), network processor, or the like. The processing device 2002 can be configured to execute instructions 2026 for performing the operations and steps discussed herein. The computer system can further include a network interface device 2008 to communicate over a network 2020.

The memory system 2010 can include a machine-readable storage medium (also known as a computer-readable medium) on which is stored one or more sets of instructions 2026 or software embodying any one or more of the methodologies or functions described herein. The instructions 2026 can also reside, completely or at least partially, within the main memory 2004 or within the processing device 2002 during execution thereof by the computer system, the main memory 2004 and the processing device 2002 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 2000 may further include a display unit, an alphanumeric input device (e.g., a keyboard), and a user interface (UI) navigation device (e.g., a mouse). In an example, one or more of the display units, the input device, or the UI navigation device may be a touch screen display. The machine 2000 may include a signal generation device (e.g., a speaker), or one or more sensors, such as a global positioning system (GPS) sensor, compass, accelerometer, or one or more other sensors. The machine 2000 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 2026 (e.g., software, programs, an operating system (OS), etc.) or other data stored on the storage system 2018 can be accessed by the main memory 2004 for use by the processing device 2002. The main memory 2004 (e.g., DRAM) is typically fast, but volatile, and thus a different type of storage than the storage system 2018 (e.g., an SSD), which is suitable for long-term storage, including while in an “off” condition. The instructions 2026 or data in use by a user or the machine 2000 are typically loaded in the main memory 2004 for use by the processing device 2002. When the main memory 2004 is full, virtual space from the memory system 2010 can be allocated to supplement the main memory 2004; however, because the memory system 2010 device is typically slower than the main memory 2004, and write speeds are typically at least twice as slow as read speeds, use of virtual memory can greatly reduce user experience due to storage system latency (in contrast to the main memory 2004, e.g., DRAM). Further, use of the storage system 2018 for virtual memory can greatly reduce the usable lifespan of the storage system 2018.

The instructions 2026 may further be transmitted or received over a network 2020 using a transmission medium via the network interface device 2008 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®, IEEE 802.15.4 family of standards, peer-to-peer (P2P) networks, among others). In an example, the network interface device 2008 may include one or more physical jacks (e.g., Ethernet, coaxial, or phone jacks) or one or more antennas to connect to the network 2020. In an example, the network interface device 2008 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 2000, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” in the absence of an express indication to the contrary); the terms “over” and “under” are expressly intended to identify a relative placement of structures (or layers, features, etc.), which expressly includes—but is not limited to—direct contact between the identified structures unless specifically identified as such. Similarly, the terms “over” and “under” are not limited to horizontal orientations, as a structure may be “over” a referenced structure if it is, at some point in time, an outermost portion of the construction under discussion, even if such structure extends vertically relative to the referenced structure, rather than in a horizontal orientation.

The terms “wafer” and “substrate” are used herein to refer generally to any structure on which integrated circuits are formed, and also to such structures during various stages of integrated circuit fabrication. The following detailed description is, therefore, not to be taken in a limiting sense, and the scope of the various embodiments is defined only by the appended claims, along with the full scope of equivalents to which such claims are entitled.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

In some embodiments described herein, different doping configurations may be applied to a select gate source (SGS), a control gate (CG), and a select gate drain (SGD), each of which, in this example, may be formed of or at least include polysilicon, with the result such that these tiers (e.g., polysilicon, etc.) may have different etch rates when exposed to an etching solution. For example, in a process of forming a monolithic pillar in a 3D semiconductor device, the SGS and the CG may form recesses, while the SGD may remain less recessed or even not recessed. These doping configurations may thus enable selective etching into the distinct tiers (e.g., SGS, CG, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (i.e., the memory cell may be programmed to an erased state).

According to one or more embodiments of the present disclosure, a memory controller (e.g., a processor, controller, firmware, etc.) located internal or external to a memory system, is capable of determining (e.g., selecting, setting, adjusting, computing, changing, clearing, communicating, adapting, deriving, defining, utilizing, modifying, applying, etc.) that a memory data error occurs during a memory operation and a memory system fault occurs. The memory controller may be configured to coordinate reporting of detection of memory data errors with detection of memory system faults.

It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Example 1 includes subject matter (such as a memory system) comprising a memory array and a memory controller. The memory array includes multiple memory cells. The memory controller is configured to access a physical memory space of the memory array as multiple sectors of a same memory size; assign a block size to a sector of the multiple sectors to store compressed data of the assigned block size; assign different block sizes to different sectors; compress write data received from a host system; write compressed write data into an invalid data block of a first sector, wherein the invalid data block has a smallest block size that can store the compressed write data; and write the compressed write data to an open data block indicated by a write cursor of a second sector assigned a block size that can store the compressed write data when an invalid data block is not available to store the compressed write data.

In Example 2, the subject matter of Example 1 optionally includes a memory controller configured to read compressed data from a data block of the first sector, wherein the first sector is assigned a first block size; decompress the compressed data; update the decompressed data with the received write data; compress the decompressed data into the compressed write data; and invalidate a data block of the first sector when the compressed write data is larger than the first block size assigned to the first sector.

In Example 3, the subject matter of one or both Examples 1 and 2 optionally includes a memory controller configured to defragment the first sector by moving valid data blocks of the first sector to data blocks of another sector that is assigned a same block size as the first sector; and defragment the first sector when a number of valid data blocks of the first sector is less than a threshold number of invalid data blocks.

In Example 4, the subject matter of Example 3 optionally includes a memory controller configured to move a valid data block of the first sector to an invalid data block of the other sector to defragment the first sector; and move the valid data block to an open data block of the other sector when an invalid data block is unavailable to store the valid data block in the other sector.

In Example 5, the subject matter of one or both of Examples 3 and 4 optionally includes a memory controller configured to move all valid data blocks out of the first sector to defragment the first sector; and update the block size assigned to the first sector.

In Example 6, the subject matter of Example 5 optionally includes a memory controller configured to lock the first sector from writes to defragment the first sector; and write compressed data blocks of the updated block size into the first sector after the first sector is defragmented.

In Example 7, the subject matter of one or any combination of Examples 1-6 optionally includes a memory controller configured to defragment the first sector by moving valid data blocks from the first sector as a circular buffer.

In Example 8, the subject matter of one or any combination of Examples 1-7 optionally includes a memory controller configured to assign a portion of the multiple sectors as page table sectors to store page tables, wherein a page table maps data blocks of the host to compressed data blocks of the memory array; and update a page table in a page table sector when the compressed write data is written.

In Example 9, the subject matter of Example 8 optionally includes a memory controller configured to recurrently change assignment of block sizes to the multiple sectors and assignment of page tables to the multiple sectors.

In Example 10, the subject matter of one or any combination of Examples 1-9 optionally includes a memory controller that includes First In First Out buffers (FIFOs), and wherein the memory controller is configured to store a pointer for invalid data blocks of a same block size in a FIFO.

Example 11 includes subject matter (such as a method of operating a memory system) or can optionally be combined with one or any combination of Examples 1-10 to include such subject matter, comprising receiving write data at a memory array of a memory system, wherein the memory array includes multiple sectors of a same memory cell size, wherein a sector is assigned a block size to store compressed data of the assigned block size and different sectors of the memory array are assigned a different block size; compressing the write data; writing compressed write data to an invalid data block of a first sector having a smallest block size that can store the compressed write data; and writing the compressed write data to an open data block indicated by a write cursor of a second sector assigned a block size that can store the compressed write data when an invalid data block is not available to store the compressed write data.

In Example 12, the subject matter of Example 11 optionally includes reading compressed data from a data block of the first sector, wherein the first sector is assigned a first block size; decompressing the compressed data; updating the decompressed data with the received write data; compressing the decompressed data into the compressed write data; and invalidating a data block of the first sector when the compressed write data is larger than the data block size assigned to the first sector.

In Example 13, the subject matter of one or both of Examples 11 and 12 optionally includes defragmenting the first sector when a number of valid data blocks of the first sector is less than a threshold number of invalid data blocks; and wherein the defragmenting includes moving the valid data blocks of the first sector to data blocks of another sector assigned the same block size as the first sector.

In Example 14, the subject matter of Example 13 optionally includes defragmenting that includes moving a valid data block of the first sector to an invalid data block of the other sector; and moving the valid data block to an open data block of the other sector when an invalid data block is unavailable for the valid data block in the other sector.

In Example 15, the subject matter of one or both of Examples 13 and 14 optionally includes removing all valid data blocks with valid data from the first sector; and updating the block size assigned to the first sector.

In Example 16, the subject matter of Example 15 optionally includes locking the first sector from writes during the defragmenting; and writing compressed data block of the updated block size into the first sector after defragmenting.

In Example 17, the subject matter of one or any combination of Examples 12-16 optionally includes defragmenting the first sector by moving compressed valid data blocks out of the first sector as a circular buffer.

In Example 18, the subject matter of one or any combination of Examples 12-17 optionally includes updating a page table in a page table sector assigned to store page tables when the compressed write data is larger than the data block size assigned to the first sector. The page table maps host data blocks to compressed data blocks of the memory array.

Example 19 can include subject matter (such as a computing system) or can optionally be combined with one or any combination of Examples 1-18 to include such subject matter, comprising a memory system including a memory array including memory cells and a memory controller operatively coupled to the memory array, and a host system configured to send host data blocks to the memory system. The memory controller is configured to access a physical memory space of the memory array as multiple sectors of a same memory size; assign a block size to the sectors to store data blocks of the assigned block size, wherein different block sizes are assigned to different sectors; assign a portion of the sectors as page table sectors, wherein a page table sector includes a page table to map the host data blocks to data blocks of the sectors; compress a host data block received from the host system into compressed write data; write the compressed write data to an invalid data block of a first sector, wherein the invalid data block has a smallest block size that can store the compressed data; write the compressed write data to an open data block indicated by a write cursor of a second sector assigned a block size that can store the compressed write data when an invalid data block is not available to store the compressed write data; and update a page table in a page table sector when the compressed write data is written.

In Example 20, the subject matter of Example 19 optionally includes a memory controller configured to read stored compressed data from a data block of the first sector, wherein the first sector is assigned a first block size; decompress the stored compressed data; update the decompressed data with the received host data block; compress the decompressed data into the compressed write data; and invalidate a data block of the first sector when the compressed write data is larger than the data block size assigned to the first sector.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A memory system comprising:
a memory array including multiple memory cells;
a memory controller configured to:
access a physical memory space of the memory array as multiple sectors of a same memory size;
assign a block size to a sector of the multiple sectors to store compressed data of the assigned block size;
assign different block sizes to different sectors;
compress write data received from a host system;
write compressed write data into an invalid data block of a first sector, wherein the invalid data block has a smallest block size that can store the compressed write data; and
write the compressed write data to an open data block indicated by a write cursor of a second sector assigned a block size that can store the compressed write data when an invalid data block is not available to store the compressed write data.

2. The memory system of claim 1, wherein the memory controller is configured to:
read compressed data from a data block of the first sector, wherein the first sector is assigned a first block size;
decompress the compressed data;
update the decompressed data with the received write data;
compress the decompressed data into the compressed write data; and
invalidate a data block of the first sector when the compressed write data is larger than the first block size assigned to the first sector.

3. The memory system of claim 1, wherein the memory controller is configured to:
defragment the first sector by moving valid data blocks of the first sector to data blocks of another sector that is assigned a same block size as the first sector; and
defragment the first sector when a number of valid data blocks of the first sector is less than a threshold number of invalid data blocks.

4. The memory system of claim 3, wherein the memory controller is configured to:
move a valid data block of the first sector to an invalid data block of the other sector to defragment the first sector; and
move the valid data block to an open data block of the other sector when an invalid data block is unavailable to store the valid data block in the other sector.

5. The memory system of claim 3, wherein the memory controller is configured to:
move all valid data blocks out of the first sector to defragment the first sector; and
update the block size assigned to the first sector.

6. The memory system of claim 5, wherein the memory controller is configured to:
lock the first sector from writes to defragment the first sector; and
write compressed data blocks of the updated block size into the first sector after the first sector is defragmented.

7. The memory system of claim 1, wherein the memory controller is configured to defragment the first sector by moving valid data blocks from the first sector as a circular buffer.

8. The memory system of claim 1, wherein the memory controller is configured to:
assign a portion of the multiple sectors as page table sectors to store page tables, wherein a page table maps data blocks of the host to compressed data blocks of the memory array; and
update a page table in a page table sector when the compressed write data is written.

9. The memory system of claim 8, wherein the memory controller is configured to recurrently change assignment of block sizes to the multiple sectors and assignment of page tables to the multiple sectors.

10. The memory system of claim 1, wherein the memory controller includes First In First Out buffers (FIFOs), and wherein the memory controller is configured to store a pointer for invalid data blocks of a same block size in a FIFO.

11. A method of operating a memory system, the method comprising:
receiving write data at a memory array of a memory system, wherein the memory array includes multiple sectors of a same memory cell size, wherein a sector is assigned a block size to store compressed data of the assigned block size and different sectors of the memory array are assigned a different block size;
compressing the write data;
writing compressed write data to an invalid data block of a first sector having a smallest block size that can store the compressed write data; and
writing the compressed write data to an open data block indicated by a write cursor of a second sector assigned a block size that can store the compressed write data when an invalid data block is not available to store the compressed write data.

12. The method of claim 11, including:
reading compressed data from a data block of the first sector, wherein the first sector is assigned a first block size;
decompressing the compressed data;
updating the decompressed data with the received write data;
compressing the decompressed data into the compressed write data; and
invalidating a data block of the first sector when the compressed write data is larger than the data block size assigned to the first sector.

13. The method of claim 11, including:
defragmenting the first sector when a number of valid data blocks of the first sector is less than a threshold number of invalid data blocks; and
wherein the defragmenting includes moving the valid data blocks of the first sector to data blocks of another sector assigned the same block size as the first sector.

14. The method of claim 13, wherein the defragmenting includes:
moving a valid data block of the first sector to an invalid data block of the other sector;
moving the valid data block to an open data block of the other sector when an invalid data block is unavailable for the valid data block in the other sector.

15. The method of claim 13, including:
removing all valid data blocks with valid data from the first sector; and
updating the block size assigned to the first sector.

16. The method of claim 15, including:
locking the first sector from writes during the defragmenting; and
writing compressed data block of the updated block size into the first sector after defragmenting.

17. The method of claim 12, including defragmenting the first sector by moving compressed valid data blocks out of the first sector as a circular buffer.

18. The method of claim 12, including:
updating a page table in a page table sector assigned to store page tables when the compressed write data is larger than the data block size assigned to the first sector; and
wherein a page table maps host data blocks to compressed data blocks of the memory array.

19. A computing system comprising:
a memory system including a memory array including memory cells, and a memory controller operatively coupled to the memory array; and
a host system configured to send host data blocks to the memory system; and
wherein the memory controller is configured to:
access a physical memory space of the memory array as multiple sectors of a same memory size;
assign a block size to the sectors to store data blocks of the assigned block size, wherein different block sizes are assigned to different sectors;
assign a portion of the sectors as page table sectors, wherein a page table sector includes a page table to map the host data blocks to data blocks of the sectors;
compress a host data block received from the host system into compressed write data;
write the compressed write data to an invalid data block of a first sector, wherein the invalid data block has a smallest block size that can store the compressed data;
write the compressed write data to an open data block indicated by a write cursor of a second sector assigned a block size that can store the compressed write data when an invalid data block is not available to store the compressed write data; and
update a page table in a page table sector when the compressed write data is written.

20. The computing system of claim 19, wherein the memory controller is configured to:
read stored compressed data from a data block of the first sector, wherein the first sector is assigned a first block size;
decompress the stored compressed data;
update the decompressed data with the received host data block;
compress the decompressed data into the compressed write data; and
invalidate a data block of the first sector when the compressed write data is larger than the data block size assigned to the first sector.
